(19) United States
(12) Patent Application Publication
(10) Pub. No.: US 2003/0082453 A1
(43) Pub. Date: May 1, 2003

(54) Secondary battery positive electrode and secondary battery using the same

(76) Inventors: Tatsuji Numata, Tokyo (JP); Takehiro Noguchi, Tokyo (JP)

Correspondence Address: KATTEN MUCHIN ZAVIS ROSENMAN, 575 MADISON AVENUE, NEW YORK, NY, 10022-2585, US

(21) Appl. No.: 10/283,830

(22) Filed: Oct. 30, 2002

(30) Foreign Application Priority Data
Oct. 31, 2001 (JP) 2001-335652

(51) Int. Cl. H01M 4/48; H01M 4/58; H01M 4/62

(52) U.S. Cl. 429/231.95; 429/232; 429/223; 429/224; 429/221; 429/220

(57) ABSTRACT

In a secondary battery using an Li-containing oxide for a positive electrode, a nitride such as TiN or ZrN or an oxide such as MoO₃, TiO, Ti₂O₃, NbO, or RuO₂ is employed as an electroconductive giving agent. Thereby a secondary battery that is excellent in battery performance, especially excellent in capacity retaining performance and charge and discharge cycle performance at a high temperature, and more specifically, a high-voltage secondary battery the energy density of which is high can be obtained.

### BACKGROUND OF THE INVENTION

1. Technical Field of the Invention

The present invention relates to a secondary battery positive electrode which can insert and extract lithium ions and a secondary battery using the same.

2. Description of the Related Art

In a nonaqueous electrolyte secondary battery using a lithium metal or a lithium compound as a negative electrode, if lithium cobalt-oxide (LiCoO₂) is used as a positive electrode active material, an electromotive force over 4V is obtained, and this lithium cobalt-oxide has been actively studied. This lithium cobalt-oxide has been widely used as a positive electrode active material for lithium ion secondary batteries for its excellent characteristics in potential flatness, capacity, discharge potential, and cycle performance. However, cobalt is expensive due to its small recoverable deposits. Furthermore, the lithium cobalt-oxide has a layered rock salt structure (α-NaFeO₂ structure) and the oxygen atom layers with high electronegativity come to be adjacent after the extraction of all the lithium ions in charging. Therefore, it becomes necessary to limit a lithium extraction amount from the lithium cobalt-oxide positive electrode in practical use, and if a lithium extraction amount is excessively large due to over-charging, a structural change in the positive electrode occurs due to the electrostatic repulsion between the oxygen atom layers and the heat generates, and this becomes a serious problem in battery safety. Therefore, an alternative material with high safety in charging for the positive electrode has been demanded.

As a positive electrode active material for a 4V-class nonaqueous electrolyte battery other than lithium cobalt-oxide, a lithium nickel-oxide (LiNiO₂) and spinel lithium manganese-oxide (LiMn₂O₄) have been considered. Although lithium nickel-oxide has a capacity larger than that of a lithium cobalt-oxide, its crystal structure is the same layered rock salt structure as that of a lithium cobalt-oxide, and due to Ni⁴⁺ instability in charged state, and the oxygen releasing temperature thereof is lower than that of the lithium cobalt-oxide, so that the safety securing becomes a problem.

On the other hand, the spinel lithium manganese-oxide uses the inexpensive manganese as a raw material and it is a stable spinel crystal. The spinel lithium manganese-oxide does not contain much extra lithium to be used when over-charging and shows high safety in comparison with the lithium cobalt-oxide. Therefore, the spinel lithium manganese-oxide is a highly promising material, and has been partly put to practical use. However, the capacity of spinel lithium manganese-oxide is low in comparison with that of the lithium cobalt-oxide, so that its advantages have not been used in the batteries for small-sized, light, and high-capacity portable equipment which requires high energy density.

Namely, although there are problems in cost and safety, the adoption of the lithium cobalt-oxide is common for the purpose of high value which places priority on high energy density.

However, recently, in accordance with the high performance of portable equipment, the demand for the improvements in the performance of batteries for the drive power sources, particularly, the demand for an increase in energy density has increased. In other words, higher-capacity positive electrode active materials and negative electrode active materials, or higher-potential positive electrode active materials have been demanded. Herein, as materials that have started to come into the limelight, 5V-class positive electrodes which have a clear plateau at 4.5V or more with respect to the lithium reference potential.

Some of these 5V-class positive electrode active materials use the redox of the metal such as Ni, Co, Fe, Cu or Cr occupying the manganese site in the spinel lithium manganese-oxide. For example, Japanese Unexamined Patent Publication No. H09-147867 discloses that Li_{x+y}M_{z}n_{2-y-z}O₄ (M=Ni, Cr) has a capacity of 4.5V or more. Furthermore, Japanese Unexamined Patent Publication No. 2000-067860 discloses Fe/Co-based 5V-class positive electrode materials. Furthermore, as similar high-potential positive electrode materials, Japanese Unexamined Patent Publication No. 2000-223158 discloses a combination with a nitride anode, and Japanese Unexamined Patent Publication No. 2000-156229 discloses a combination with a Ti oxide anode. Furthermore, Japanese Unexamined Patent Publication No. H07-192768 discloses a high-potential positive electrode material having an inverse spinel structure, and recently, an olivine-type high-potential material has been reported.

Particularly, a 5V-class positive electrode material using LiNi_{0.5}Mn_{1.5}O₄ as a base shows a plateau in the vicinity of 4.7V in a metal Li counter electrode, and is expected to have a charge and discharge capacity of 120 Ah/g or more, so that this material is a promising material in terms of an increase in battery energy density. Also, focusing on the high potential for the 5V-class positive electrode material, even when an anode material with a potential higher than that of a conventional anode using a carbon material as a base, the securing of a prescribed battery voltage becomes possible, so that selection of an anode material becomes flexible. And in a case where such a battery is used for an assembled battery, the number of batteries can be reduced, and it is expected that this contributes to weight saving, space saving, and cost reduction.

In such a high-potential positive electrode material, other transition metals are substituted at a high ratio of approximately ¼ through ½ of the Mn site, so that it is not easy to realize a uniform solid solution, however, a uniform mixture using the sol-gel method (Journal of Electrochemical Society, Vol. 143, p.1607, (1996)), precursor synthesis by a coprecipitation method (Japanese Unexamined Patent Publication No. 2001-185145), and a liquid phase synthesis method using nitrate of transition metals (Japanese Unexamined Patent Publication No 2001-185148) have been attempted, and the synthesis of high-quality high-potential positive electrode active materials has been actively studied.

However, although the initial charge and discharge capacity of the designed value was obtained in the trial manufacturing and the evaluation by inventors of the present invention of the battery using the above-mentioned high-potential material synthesized by paying attention to uniform solution as a positive electrode, the cycle performance, the capacity retaining performance, and the self-discharge performance at the high temperature of 40-60° C. were not satisfactory.

### SUMMARY OF THE INVENTION

An object of the present invention is to provide a secondary battery positive electrode having improved capacity retaining performance and cycle performance at a high temperature while maintaining safety and productivity and achieving a reduction in size in a 5V-class secondary battery, and to provide a secondary battery using the same.

A secondary battery positive electrode according to the present invention comprises:

a positive electrode active material which can insert and extract lithium ion; and

an electroconductive giving agent containing one or two or more kinds selected from a group consisting of Ti, Zr, Mo, Nb, and Ru and compounds containing these elements.

The compounds can be oxides, nitrides, or mixture of them.

The electroconductive giving agent can contain one or two or more kinds of compounds selected from a group consisting of TiN, ZrN, MoO₃TiO, Ti₂O₃, NbO and RuO₂.

Furthermore, the electroconductive giving agent can be synthesized so as to contain a Ti simple substance of a Ti-containing compound. Concretely, the electroconductive giving agent can contain one or two or more kinds of compounds selected from a group consisting of TiN, TiO, and Ti₂O₃.

Furthermore, a positive electrode active material in the invention has a plateau at 4.5V or more of a metal lithium counter electrode potential. As such a positive electrode active material, for example, there is a material containing a lithium-containing complex oxide. As a lithium-containing complex oxide, a spinel lithium manganese complex oxide is illustrated. A lithium-containing complex oxide can be a compound shown by the following general formula (1).

Liₐ(MₓMn_{2-x-y}A_{y})O₄ (1)

In this formula, 0<x, 0 y, x+y<2, and 0<a<1.2. “M” denotes at least one kind selected from a group consisting of Ni, Co, Fe, Cr, and Cu. “A” denotes at least one kind selected from the group consisting of Si and Ti.

A secondary battery according to the present invention comprises the abovementioned secondary battery positive electrode, an anode, and an electrolyte. In this secondary battery, the electrolyte can contain LiPF₆ as a supporting electrolyte. Furthermore, in this secondary battery, an average discharge voltage with respect to the lithium reference potential can be set to 4.5 or more.

### BRIEF DESCRIPTION OF THE DRAWINGS

FIG. 1 is a diagram showing cycle performance of cylindrical 18650 cells of an embodiment of the invention and a comparative example at 50° C.

### DETAILED DESCRIPTION OF THE PREFERRED EMBODIMENTS

Hereinafter, the present invention will be described in detail. The present inventors variously examined the reason for the insufficient high-temperature cycle performance of the conventional 5V-class secondary batteries, and found that the anions generated due to the dissociation of the supporting electrolyte in the electrolyte were doped into the carbon material that is the electroconductive giving agent in the positive electrode, and they obstructed the improvements in cycle performance for the batteries.

In a case where an Li-containing oxide having a plateau at 4.5V or more of a metal Li counter electrode potential as a positive electrode active material, when the battery is charging, the potential of the positive electrode becomes 4.5V or more in the metal Li counter electrode. In such a high-potential condition, the dissociation of a supporting electrolyte in an electrolyte caused the doping of the anions generated into a carbon material that is an electroconductive giving agent existing in the positive electrode. When such the phenomenon occurs, the retaining capacity after storage decreases. When charging and discharging are further repeated, the anions generated from the supporting electrolyte are repeatedly doped into and de-doped from an electroconductive giving agent, and this causes repeated changes in volume of the carbon material in the positive electrode, and the exfoliation of the active material from current collector metals occurs, resulting in a shortened cycle life. Particularly, in a case where LiPF₆ is used as a supporting electrolyte and a battery is stored or cyclically charged and discharged in an environment of a high temperature of 40° C. to 60° C., the abovementioned phenomenon becomes more conspicuous. Namely, the capacity retaining performance and cycle life at a high temperature significantly deteriorates.

Such the phenomenon has not been found in the conventional 4V-class Li ion secondary batteries, and the suppression of such the phenomena mentioned above is a technical theme unique to 5V-Class Li ion secondary batteries.

As a method for achieving the above-mentioned technical theme, for example, the application of the technique in which an Al powder is used as an electroconductive giving agent in place of the carbon material is considered. Doping of the anions generated due to dissociation of a supporting electrolyte into a carbon material is carried out by insertion of the anions between layers of a carbon material that is an electroconductive giving agent existing in the positive electrode, so that the use of the material having no layered structure such as an Al powder as an electroconductive giving agent is considered as one of the methods to suppress the phenomena mentioned above. In actuality, in a nonaqueous electrolyte secondary battery using an Li-containing oxide that has a plateau at 4.5V or more in a metal Li counter electrode as a positive electrode, by using an Al powder having an appropriate particle size as an electroconductive giving agent, capacity retaining performance under an environment of a high temperature is improved. In addition, in place of the Al powder, application of a SUS powder, a Mg metal, or a fibriform carbon can be considered. Since a SUS metal and a Mg metal have no layered structure, and a fibriform carbon has an edge form different from that of the massive or the flake graphite, as in the case with the Al powder, there is a possibility that the doping of the anions generated due to the dissociation of a supporting electrolyte can be avoided.

However, in actuality it is difficult to use the abovementioned materials as an electroconductive giving agent in a positive electrode for the following reasons.

In the case of the Al powder, there is a danger of the sudden heat generation, the explosion due to the oxidation and the operator health hazards due to expiration, so that selection of the Al powder is not practical in actual production to which it is expected to treat in large quantities. As for the use of the SUS powder, the domination weakens in the usage in which the energy density is valued so that the battery may become heavy. Furthermore, in the case of the Mg metal, a battery becomes unendurable at a potential of 4.5 or more, so that it is difficult to use the Mg metal in a 5V-class secondary battery. In addition, the fibroid carbon might promote the decomposition of the electrolyte in the state of high potential though it can control the dope to the positive electrode of the anions generated due to the dissociation of the supporting electrolyte. It is necessary to pay closer attention to the shape, the amount of addition, and the mixture condition of a fibroid carbon for that.

The inventors of the present invention diligently examined the various materials of the electroconductive giving agent for the positive electrode active material while checking the six points that (1) anions generated due to the dissociation of a supporting electrolyte were not doped even in a condition with a high potential of 4.5V or more in a metal Li counter electrode, (2) dissolution was not caused even in a condition with a high potential of 4.5V or more in a metal Li counter electrode, (3) ion diffusion was not obstructed, (4) electron conduction was aided, (5) there was less danger of dust explosion, and (6) decomposition of the electrolyte was not promoted. As a result, they found that specific compounds were preferable as electroconductive giving agents, and reached the present invention.

According to the present invention, as mentioned above, a specific electroconductive giving agent is used for a positive electrode. This electroconductive giving agent is chemically stable even in a high-potential and/or high-temperature condition, and the doping of the anions generated due to the dissociation of a supporting electrolyte into the electroconductive giving agent can be effectively suppressed. Therefore, a secondary battery having significantly improved capacity retaining performance and cycle performance at a high temperature is realized.

A metal of Ti, Zr, Mo, Nb, or Ru or a compound (including alloy) containing this metal can be used as an electroconductive giving agent in the present invention. Among these, as most preferable electroconductive giving agents, the following substances are exemplified.

(i) oxides, nitrides, or mixture of them

(ii) one or two or more compounds selected from a group consisting of TiN, ZrN, MoO₃, TiO, Ti₂O₃, NbO, and RuO₂

(iii) Ti or Ti-containing compounds (for example, one or two or more compounds selected from a group consisting of TiN, TiO, and Ti₂O₃)

Use of the metal Such as Al, Mg or SUS mentioned above for the electroconductive giving agent has the following harmful effects. First, in use of a metal as an electroconductive giving agent, the metal is introduced in the form of small size particles, and in this case, heat is easily generated by oxidation, and this results in a lowering in battery performance. Second, when a metal is used for an electrode of a 5V-class battery, there is a concern that the oxidation potential of the metal is exceeded and the electroconductive giving agent is damaged by a high voltage. Considering this point, oxides and nitrides are chemically stable, and heat generation due to oxidation and damage due to a high voltage hardly occur. Therefore, they can be preferably used as an electrode material of a 5V-class battery. Furthermore, one or two or more compounds selected from a group consisting of TiN, ZrN, MoO₂, TiO, Ti₂O₃, NbO, and RuO₂, shown in (ii), are excellent in chemical stability at a high temperature, and can be preferably used as an electrode material of a 5V-class battery. It is preferable that the abovementioned electroconductive giving agent is uniformly dispersed in a positive electrode, however, it is also possible that the electroconductive giving agent is made to adhere and cover the particle surfaces of a positive electrode active material. The shape of the additive is not especially limited to a massive, spherical, or platy shape, and also, it is allowed that the particle size is properly selected depending on the particle size of the positive electrode active material, the layer thickness of the positive electrode, the positive electrode density, and the binder type, and in terms of uniform dispersion, the particle size of the additive is preferably 10 μm or less.

Although the present invention can also be applied to conventional 4V-class secondary batteries and 3V-class secondary batteries, the application to 5V-class batteries is more effective. This is because the invention can significantly improve various characteristics in a high-potential condition. From such viewpoints, as a positive electrode active material to be used in the invention, a material having a plateau at 4.5V or more of a metal lithium counter electrode potential is preferable. For example, lithium-containing complex oxides are preferably used.

As a lithium-containing complex oxide, a spinel lithium manganese complex oxide is illustrated. A compound shown in the following general formula (1) can be used as the lithium-containing complex oxide.

Liₐ(MₓMn_{2-x-y}A_{y})O₄ (1)

Herein, 0<x,0 y, x+y<2, and 0<a<1.2. “M” denotes at least one kind selected from a group consisting of Ni, Co, Fe, Cr, and Cu. “A” denotes at least one kind selected between Si and Ti.

Use of such a compound realizes a stable high electromotive force for the battery. Herein, “M” is made to contain at least Ni, whereby cycle performance is further improved. x is preferably set to be within a range in which the valence of Mn becomes +3.9 or more. In the abovementioned compound, by setting 0<y, Mn is substituted by a lighter element, a discharge amount per weight is increased, and an increase in capacity can be achieved.

As starting materials to be used for synthesis of the positive electrode active material shown by the abovementioned formula (1), Li₂CO₃, LiOH, Li₂O, or Li₂SO₄ can be used as an Li source, and MnO₂, Mn₂O₃, Mn₃O₄, MnOH, MnCO₃, or Mn(NO) can be used as an Mn source. As an Ni source, NiO, Ni(OH)₂, or Ni(NO₃)₂ can be used. Furthermore, a Mn—Ni complex hydroxide, carbonate, or oxide in which Mn and Ni have been adjusted to a predetermined ratio in advance can also be used. In a case where Si or Ti substitution is carried out, as an Si source, SiO₂ or SiO₂ hydrate or SiO can be selected, and as a Ti source, TiO₂ or TiCl₄ can be selected. Among these elements, Li₂CO₃ as an Li source, MnO₂ or Mn₂O₃ as an Mn source, and NiO or Ni(OH)₂ as an Ni source are more preferable, however, if an Mn—Ni complex oxide with a predetermined Mn—Ni ratio can be acquired, use of such a precursor is still more preferable.

Next, a positive electrode active material synthesis method will be described. The abovementioned starting materials are properly selected, weighed, and mixed so as to be at a predetermined metal composition ratio. At this point, the particle sizes of the reagents are preferably 10 μm or less to prevent residual of a NiO hetero-phase. Mixing is carried out by using a ball mill, jet mill, or pin mill, which can be selected depending on the particle size and hardness of the selected reagents. The obtained mixed powder is sintered in the air or oxygen at a temperature in a range of 600 to 950° C. In the case of Mn and Ni or a substituted material, in view of uniform solution of Ti and Si, high-temperature sintering is preferable. However, if oxygen deficiency occurs, a 4V foot occurs or cycle performance deteriorates, so that the range of the sintering temperature is especially preferably between 700° C. and 850° C.

The specific surf ace area of the obtained Li-containing oxide is desirably 3 m²/g or less, and more desirably 1 m²/g or less. Thereby, the binder necessary amount can be reduced, and a battery whose energy density is sufficiently high can be obtained.

The particle shape of the positive electrode active material is not especially limited to a massive, spherical, or platy shape, and also the particle size and the specific surface area may be in ranges that are properly selected depending on the positive electrode active material particle size, positive electrode layer thickness, positive electrode density, and binder type, however, in order to maintain a high energy density, a particle shape, particle distribution, an average particle size, a specific surface area, and a true density that achieve a positive electrode density of 2.8 g/cc at a portion at which a current collector metallic foil has been removed are desirable.

The obtained positive electrode active material is mixed with a binder type that is properly selected in accordance with characteristics considered important for the battery such as rate performance, low-temperature discharge performance, pulse discharge performance, energy density, and reductions in weight and size, and the abovementioned additive to form an electrode. As the binder, the employed resin-based binding agent is normally appropriate, and polyvinylidene fluoride (PVDF) or polytetorafluoroethylene (PTFE) can be used. As the current collector metallic foil, an Al foil is preferable.

A material of an anode to be used in the invention is desirably a material selected among an Li metal, an Li alloy, and a carbon material, into and from which Li ions can be inserted and extracted, however, since the potential of the positive electrode active material is high, a metal, a metal oxide, a compound material containing these metal and metal oxide and a carbon material, a transition metal oxide, and others, which can alloy with Li, can be used. Selection of the anode material can be properly carried out in accordance with the purpose of use of the battery, that is, the capacity, voltage, weight, size, rate performance, low-temperature discharge performance, and pulse discharge performance.

The anode active material is mixed with a binder type which is properly selected in accordance with characteristics considered important for the battery such as rate performance, low-temperature discharge performance, pulse discharge performance, energy density, and reductions in weight and size, to form an electrode. As the binder, an employed polyvinylidene fluoride (PVDF) or polytetrafluoroethylene (PTFE) can be used, and also, a rubber-based binder can be used. As a current collector metallic foil, a Cu foil is preferable.

A separator is not especially limited, and a woven fabric, a glass fiber, or a porous synthetic resin film can be used. For example, a polypropylene-based or polyethylene-based porous film is proper in terms of a large area, film strength, and film resistance since it is thin. As a solvent of a nonaqueous electrolyte, a solvent that is normally used is sufficient, for example, carbonates, chlorinated hydrocarbon, ethers, ketones, and nitrils can be used. Preferably, at least one kind is selected among ethylene carbonate (EC), propylene carbonate (PC), and γ-butyrolactone (GBL) as a high-dielectric constant solvent, and at least one kind is selected among diethylcarbonate (DEC), dimethylcarbonate (DMC), ethylmethylcarbonate (EMC), and esters as a low-viscosity solvent, and a liquid mixture of these selected solvents is used. EC+DEC, PC+DMC, PC+EMD, and PC+EC+DEC are preferable, however, in a case where the solvent purity is low or the water content is high, it is preferable that a mixing rate (%) of a solvent whose potential window is wide at a high potential side is increased. Furthermore, it is also possible that a slight amount of an additive is added for the purpose of moisture consumption or oxidation resistance improvement.

As a supporting electrolyte, at least one kind selected from the group consisting of LiBF₄, LiPF₆, LiClO₄, LiASF₆, LiSbF₆, LiCF₃SO₃, Li(CF₃SO₂)N, LiC₄F₉SO₃, Li(CF₃SO₂)₃C, and Li(C₂F₅SO₂)₂N is used, however, a system containing LiPF₆ is preferable for realizing a high-potential battery and because it becomes possible to maximize the effects of the invention. The concentration of the supporting electrolyte is preferably 0.8M to 1.5M, and more preferably 0.9M to 1.2M.

As a shape of a secondary battery relating to the invention, various types such as a prismatic type, a paper type, a lamination type, a cylindrical type, and a coin type can be employed. An outer sheath material and other component materials are not especially limited, and they may be selected in accordance with the battery shape.

Hereinafter, the results of verification on the effects of the invention, obtained by actually manufacturing a secondary battery positive electrode of the invention and evaluating performance of a secondary battery using this manufactured positive electrode, will be described.

Positive electrode active materials to be used in the examples shown below have plateaus at 4.5V or more of a metal lithium counter electrode potential.

[Synthesis of LiNi_{0.5}Mn_{1.5}O₄]

For synthesis of LiNi_{0.5}Mn_{1.5}O₄, as starting materials, Li₂CO₃ and (Mn_{0.75}Ni_{0.25})₃O₄ were used. As a stage prior to mixing of these starting materials, for the purpose of improving reactivity and obtaining a positive electrode active material having a target particle size, pulverization of Li₂CO₃ and classification of (Mn_{0.75}Ni_{0.25})₃O₄ are carried out. In a case where LiNi_{0.5}Mn_{1.5}O₄ is used as a positive electrode active material, in view of securing reaction uniformity, ease in slurry preparation, and safety, a preferable particle size is 5 μm to 20 μm, so that the particle size of (Mn_{0.7}Ni_{0.25})₃O₄ was also set to 5 μm to 20 μm that is the same as the target particle size of LiNi_{0.5}Mn_{1.5}O₄. At this point, the particle size D50 was 12 μm.

On the other hand, for securing a uniform reaction, it is desirable that the particle size of Li₂CO₃ is 5 μm or less, so that pulverization was carried out so that the particle size D50 became 1.4 μm.

Li₂CO₃ and (Mn_{0.75}Ni_{0.25})₃O₄ thus prepared so as to have a predetermined particle size were mixed so as to satisfy [Li]/[Mn]=1.0/1.5.

This mixed powder was sintered at 750° C. under an atmosphere of oxygen flows. Next, fine particles whose particle sizes are 1 μm or less in the particles of the obtained LiNi_{0.5}Mn_{1.5}O₄ were removed by an air classifier. The specific surface area of the LiNi_{0.5}Mn_{1.5}O₄ obtained at this point was 0.9m²/g. The tap density was 2.39 g/cc, the true density was 4.42 g/cc, the particle size D50 was 13 μm, the lattice constant was 8.175 angstroms.

[Synthesis of LiCoMnO₄]

Synthesis of LiCoMnO₄ was carried out according to the same procedures as of LiNi_{0.5}Mn_{1.5}O₄ except that Li₂CO₃ and (Mn_{0.5}CO_{0.5})₃O₄ were used as starting materials, mixing was carried out at a mixing ratio of [Li]/[Mn]=1/1, and the sintering temperature was set to 800° C. The obtained LiCoMnO₄ had powder characteristics in which the specific surface area was 1.1 m²/g, the tap density was 2.45 /cc, the true density was 4.47 g/cc, and the lattice constant was 8.042 angstroms.

[Synthesis of LiNi_{0.5}Mn_{1.3}Ti_{0.2}O₄]

For synthesis of LiNi_{0.5}Mn_{1.3}Ti_{0.2}O₄, as starting materials Li₂CO₃, NiO, MnO₂, and TiO₂ were used. This synthesis was carried out according to the same procedures as for LiNi_{0.5}Mn_{1.5}O₄ except that the D50 particle sizes of NiO, MnO₂, and TiO₂ were set to 0.5 μm, 8 μm, and 0.7 μm, respectively, mixing was carried out at a mixing ratio of [Li]/[Ni]/[Mn]/[Si]=1/0.5/1.3/0.2, and the sintering temperature was set to 720° C. The obtained LiNi_{0.5}Mn_{1.3}Ti_{0.2}O₄ had powder characteristics in which the specific surface area was 1.3 m²/g, the tap density was 2.18 g/cc, the true density was 4.45 g/cc, and the lattice constant was 8.199 angstroms.

[Synthesis of LiNi_{0.5}Mn_{1.45}Si_{0.05}O₄]

For synthesis of LiNi_{0.5}Mn_{1.45}Si_{0.05}O₄, as starting materials, Li₂CO₃, NiO, MnO₂, and SiO were used. This synthesis was carried out according to the same procedures as for LiNi_{0.5}Mn_{1.5}O₄ except that the D50 particle sizes of NiO, MnO₂, and TiO₂ were set to 0.5 μm, 8 μm, and 0.1 μm, respectively, mixing was carried out at a mixing ratio of [Li]/[Ni]/[Mn]/[Si]=1/0.5/1.45/0.05, and the sintering temperature was set to 780° C. The obtained LiNi_{0.5}Mn_{1.45}Si_{0.05}O₄ had powder characteristics in which the specific surface area was 1.5 m²/g, the tap density was 2.03 g/cc, the true density was 4.25 g/cc, and the lattice constant was 8.172 angstroms.

### COMPARATIVE EXAMPLE 1

A cylindrical 18650 cell (diameter: 18 mm, length: 65 mm) using LiNi_{0.5}Mn_{1.5}O₄ thus prepared as a positive electrode active material was manufactured. First, LiNi_{0.5}Mn_{1.5}O₄ and an electroconductive giving agent were dry-mixed, and evenly dispersed in N-methyl-2-pyrrolidone (NMP) in which PVDF as a binder was dissolved, whereby a slurry was prepared. As the conductivity giving agent, graphite having an average particle size of 5 μm was used. This slurry was applied on an aluminum metallic foil with a thickness of 25 μm, and then NMP was vaporized, whereby a positive electrode sheet was formed. The solid content ratio in the positive electrode was set to a mixing ratio of LiNi_{0.5}Mn_{1.5}O₄: conductivity giving agent: PVDF=80:10:10 (% by weight).

On the other hand, graphite and PVDF were mixed at a ratio of 90:10 (% by weight), dispersed in NMP, and then applied on an a copper foil with a thickness of 20 μm, whereby an anode sheet was prepared.

The positive electrode and anode sheets thus manufactured were wound up by interposing a polyethylene porous film separator with a thickness of 25 μm to form a cylindrical cell.

For an electrolyte, LiPF₆ of 1M was used as a supporting electrolyte, and a mixed solution of ethylene carbonate (EC) and diethylcarbonate (DEC) (50:50 (% by weight)) was used as a solvent.

### COMPARATIVE EXAMPLE 2

A cylindrical 18650 cell was manufactured according to the same procedures as in the comparative example 1 except that LiCoMnO₄ was used as the positive electrode active material.

### EXAMPLE 1a

A cylindrical 18650 cell was manufactured according to the same procedures as in the Comparative example 1 except that the solid content ratio in the positive electrode was set to a mixing ratio of LiNi_{0.5}Mn_{1.5}O₄:TiN:PVDF=80:10:10 (% by weight). As TiN, a first grade product by Wako Pure Chemical industries, Ltd. was used.

### EXAMPLE 1b

A cylindrical 18650 cell was manufactured according to the same procedures as in the Comparative example 1 except that the solid content ratio in the positive electrode was set to a mixing ratio of LiNi_{0.5}Mn_{1.5}O₄:TiC:PVDF=80:10:10 (% by weight). As TiC, a first grade product by Wako Pure Chemical Industries, Ltd. was used.

### EXAMPLE 1c

A cylindrical 18650 cell was manufactured according to the same procedures as in the Comparative example 1 except that the solid content ratio in the positive electrode was set to a mixing ratio of LiNi_{0.5}Mn_{1.5}O₄:TiSi₂:PVDF=80:10:10 (% by weight). As TiSi₂a first grade product (2 to 5 μm) by Wako Pure Chemical Industries, Ltd. was used.

### EXAMPLE 2

A cylindrical 18650 cell was manufactured according to the same procedures as in the Comparative example 1 except that the solid content ratio in the positive electrode was set to a mixing ratio of LiNi_{0.5}Mn_{1.5}O₄:ZrN:PVDF=80:10:10 (% by weight). As ZrN, a first grade product by Wako Pure Chemical Industries, Ltd. was used.

### EXAMPLE 3

A cylindrical 18650 cell was manufactured according to the same procedures as in the Comparative example 1 except that the solid content ratio in the positive electrode was set to a mixing ratio of LiNi_{0.5}Mn_{1.5}O₄:MoO₂:PVDF=80:10:10 (% by weight). As MoO₃, a first grade product by Wako Pure Chemical Industries, Ltd. was used.

### EXAMPLE 4

A cylindrical 18650 cell was manufactured according to the same procedures as in the Comparative example 1 except that the solid content ratio in the positive electrode was set to a mixing ratio of LiNi_{0.5}Mn_{1.5}O₄:TiO:PVDF=80:10:10 (% by weight). As Tio, the product by Junsei Chemical Co., Ltd. was used.

### EXAMPLE 5

A cylindrical 18650 cell was manufactured according to the same procedures as in the Comparative example 1 except that the solid content ratio in the positive electrode was set to a mixing ratio of LiNi_{0.5}Mn_{1.5}O₄:Ti₂O₃:PVDF=80:10:10 (% by weight). As Ti₂O₃, the product by Aldrich (99.9%) was used.

### EXAMPLE 6

A cylindrical 18650 cell was manufactured according to the same procedures as in the Comparative example 1 except that the solid content ratio in the positive electrode was set to a mixing ratio of LiNi_{0.5}Mn_{1.5}O₄:NbO:PVDF=80:10:10 (% by weight) As NbO, the product by Aldrich (99.9%) was used.

### EXAMPLE 7a

A cylindrical 18650 cell was manufactured according to the same procedures as in the Comparative example 1 except that the solid content ratio in the positive electrode was set to a mixing ratio of LiNi_{0.5}Mn_{1.5}O₄:RuO₂:PVDF=80:10:10 (% by weight). As RuO₂, the product (>99.9%) by Kanto Kagaku was used.

### EXAMPLE 7b

A cylindrical 18650 cell was manufactured according to the same procedures as in the Comparative example 1 except that the solid content ratio in the positive electrode was set to a mixing ratio of LiNi_{0.5}Mn_{1.5}O₄:RuO₂:TiN:PVDF=80:10:5:5 (% by weight). As RuO₂, the product by Kanto Kagaku (>99.9%) was used.

### EXAMPLE 8a

A cylindrical 18650 cell was manufactured according to the same procedures as in the Comparative example 2 except that the solid content ratio in the positive electrode was set to a mixing ratio of LiCoMnO₄:TiN:PVDF=80:10:10 (% by weight).

### EXAMPLE 8b

A cylindrical 18650 cell was manufactured according to the same procedures as in the Comparative example 2 except that the solid content ratio in the positive electrode was set to a mixing ratio of LiCoMnO₄:TiC:PVDF=80:10:10 (% by weight). As TiC, a first grade product by Wako Pure Chemical Industries, Ltd. was used.

### EXAMPLE 8c

A cylindrical 19650 call was manufactured according to the same procedures as in the Comparative example 2 except that the solid content ratio in the positive electrode was set to a mixing ratio of LiCoMnO₄:TiSi₂:PVDF=80:10:10 (% by weight). As TiSi₂, a first grade product (2 to 5 μm) by Wako Pure Chemical Industries, Ltd. was used.

### EXAMPLE 9

A cylindrical 18650 cell was manufactured according to the same procedures as in the Comparative example 2 except that the solid content ratio in the positive electrode was get to a mixing ratio of LiCoMnO₄:ZrN:PVDF=80:10:10 (% by weight).

### EXAMPLE 10

A cylindrical 18650 cell was manufactured according to the same procedures as in the Comparative example 2 except that the solid content ratio in the positive electrode was set to a mixing ratio of LiCoMnO₄:MoO₃:PVDF=80:10:10 (% by weight).

### EXAMPLE 11

A cylindrical 18650 cell was manufactured according to the same procedures as in the Comparative example 2 except that the solid content ratio in the positive electrode was set to a mixing ratio of LiCoMnO₄:TiO:PVDF=80:10:10 (% by weight).

### EXAMPLE 12

A cylindrical 18650 cell was manufactured according to the same procedures as in the Comparative example 2 except that the solid content ratio in the positive electrode was set to a mixing ratio of LiCoMnO₄:Ti₂O₃:PVDF=80:10:10 (% by weight).

### EXAMPLE 13

A cylindrical 18650 cell was manufactured according to the same procedures as in the Comparative example 2 except that the solid content ratio in the positive electrode was set to a mixing ratio of LiCoMnO₄:NbO:PVDF=80:10:10 (% by weight).

### EXAMPLE 14a

A cylindrical 18650 cell was manufactured according to the same procedures as in the Comparative example 2 except that the solid content ratio in the positive electrode was set to a mixing ratio of LiCoMnO₄:RuO₂:PVDF=80:10:10 (% by weight).

### EXAMPLE 14b

A cylindrical 18650 cell was manufactured according to the same procedures as in the Comparative example 2 except that the solid content ratio in the positive electrode was set to a mixing ratio of LiCoMnO₄:RuO₂:TiN: PVDF=80:10:5:5 (% by weight). As RuO₂, the product (>99.9%) by Kanto Kagaku was used.

### EVALUATION TEST EXAMPLE 1

Capacity retaining performance of the cylindrical 18650 cells manufactured in Comparative examples 1 and 2 and Examples 1 through 14 was evaluated.

First, charging and discharging of each cylindrical cell were carried out once each at the room temperature. At this point, the charging current and discharging current are both 200 mA, and this discharging capacity was defined as an initial capacity. The lower cut-off voltage was 3.0V in all cells. However, the upper cut-off voltage was set to 4.9V in Comparative example 1 and Examples 1 through 7 using LiNi_{0.5}Mn_{1.5}O₄ was used as the positive electrode active material, and on the other hand, the upper cut-off voltage was 5.0V in Comparative example 2 and Examples 8 through 14 using LiCoMnO₄ as the positive electrode active material. Thereafter, the respective cells were charged at 200 mA up to a predetermined voltage (4.9V in Comparative example 1 and Examples 1 through 7, and 5.0V in Comparative example 2 and Examples 8 through 14), and after being further charged for three hours at a constant voltage, the cells were left for 2 weeks in a thermostatic incubator at a temperature of 50° C. After being left for 2 weeks, the cells were discharged again at 200 mA at the room temperature, and the capacity at this point was defined as a retention capacity.

Furthermore, after measuring the retention capacity, one more charging and discharging operation was repeated at 200 mAh, and the discharge capacity at this point was defined as a recover capacity.

The capacity retention rates (=100×[retention capacity]/[initial capacity]) and the capacity recovery rates (=100×[recovery capacity]/[initial capacity]) of the respective cylindrical cells after being left for 2 weeks at 50° C. are shown in Table 1.

It was found that, in comparison with the Comparative example 1, the capacity retention rates and the capacity recovery rates in Examples 1 through 7 were improved. Likewise, it was confirmed that, in comparison with Comparative example 2, the capacity retention rates and the capacity recovery rates in Examples 8 through 14 were improved. Namely, no matter which material of LiNi_{0.5}Mn_{1.5}O₄ and LiCoMnO₄ was used as a positive electrode active material, by replacing graphite in the positive electrode by a nitride such as TiN or ZrN or an oxide such as MoO₃, TiO, Ti₂O₃, NbO, or RuO₂, capacity retaining performance at 50° C. can be significantly improved. Even in a case where the same test was conducted by using TaN and HfN, the same improving effect as in the case with TiN and ZrN could be obtained.

### EVALUATION TEST EXAMPLE 2

Next, a cycle evaluation test was conducted for the cylindrical 18650 cells manufactured by Comparative examples 1 and 2 and Examples 1 through 14.

In the cycle evaluation test, an operation was repeated in which charging was carried out at 500 mA up to a predetermined voltage (4.9V in Comparative example 1 and Examples 1 through 7, and 5.0V in Comparative example 2 and Examples 8 through 14), and thereafter, constant-voltage charging for 2 hours was carried out, and then discharging at 500 mA up to 3.0V was carried out. This test was conducted at a temperature of 20° C. and 50° C.

Table 2 shows [discharging capacity at the three hundredth cycle]/[discharging capacity at the fifth cycle] (%) of the respective cells.

It is understood that in both cases of LiNi_{0.5}Mn_{1.5}O₄ and LiCoMnO4 used as a positive electrode active material, capacity retaining performance accompanied with cycles has been improved. Particularly, the degree of improvement at 50° C. is more remarkable than that at 20° C.

### COMPARATIVE EXAMPLE 3

A 18650 cylindrical cell was manufactured according to the same procedures as in the Comparative example 1 except that LiNi_{0.5}Mn_{1.3}Ti_{0.2}O₄ was used as the positive electrode active material.

### COMPARATIVE EXAMPLE 4

A 18650 cylindrical cell was manufactured according to the same procedures as in the Comparative example 3 except that a solution of EC:DEC=50:50 (% by volume) in which LiPf₆ of 0.5M and Li(C₂F₅SO₂)₂N of 0.5M were dissolved was used as an electrolyte.

### EXAMPLE 15

A cylindrical 18650 cell was manufactured according to the same procedures as in the Comparative example 4 except that the solid content ratio in the positive electrode was set to a mixing ratio of LiNi_{0.5}Mn_{1.3}Ti_{0.2}O₄:TiN:PVDF=80:10:10 (% by weight).

### EVALUATION TEST EXAMPLE 3

Capacity retaining performance of the cylindrical 18650 cells manufactured in Comparative examples 1, 3, and 4 and Example 15 was evaluated. The evaluation test conditions were set identical to those in Evaluation test example 1, and the upper cut-off voltage was set to 4.9V and the lower cut-off voltage was set to 3.0V.

Table 3 shows the capacity recovery rates of the respective cells. In comparison by using the same graphite as an electroconductive giving agent, it was found that LiNi_{0.5}Mn_{1.3}Ti_{0.2}O₄ obtained by applying Ti-substitution to the Mn-site of LiNi_{0.5}Mn_{1.5}O₄ showed higher capacity retaining performance, and for this 5V-class positive electrode active material to which Ti-substitution had been applied, by using TiN as the conductivity giving agent, capacity retaining performance was further improved. It has been proved by the previous Evaluation test example 1 that TiN-addition is effective in the case where LiPF₆ is used as a supporting electrolyte of the electrolyte, and furthermore, based on comparison between Comparative example 4 and Example 15 using LiPF₆+Li(C₂F₅SO₂)₂N as a supporting electrolyte of the electrolyte, it was found that TiN-addition was also effective in a case using LiPF₆+Li(C₂F₅SO₂)₂N as a supporting electrolyte of the electrolyte.

### COMPARATIVE EXAMPLE 5

A cylindrical 18650 cell was manufactured according to the same procedures as in the Comparative example 1 except that LiNi_{0.5}Mn_{1.5}Si_{0.05}O₄ was used as the positive electrode active material.

### EXAMPLE 16

A cylindrical 18650 cell was manufactured according to the same procedures as in the Comparative example 5 except that the solid content ratio in the positive electrode was set to a mixing ratio of LiNi_{0.5}Mn_{1.45}Si_{0.05}O₄:graphite:Ti₂O₃:PVDF=80:5:5:10 (% by weight).

### EXAMPLE 17

A cylindrical 18650 cell was manufactured according to the same procedures as in the Comparative example 5 except that the solid content ratio in the positive electrode was set to a mixing ratio of LiNi_{0.5}Mn_{1.45}Si_{0.05}O₄:graphite:Ti₂O₃:PVDF=80:3:7:10 (% by weight).

### EVALUATION TEST EXAMPLE 4

A cycle evaluation test was conducted for the cylindrical 18650 cells manufactured in Comparative example 5 and Examples 16 and 17. The evaluation conditions were set identical to those in the Evaluation test example 2, and the upper cut-off voltage was set to 4.9V and the lower cut-off voltage was set to 3.0V.

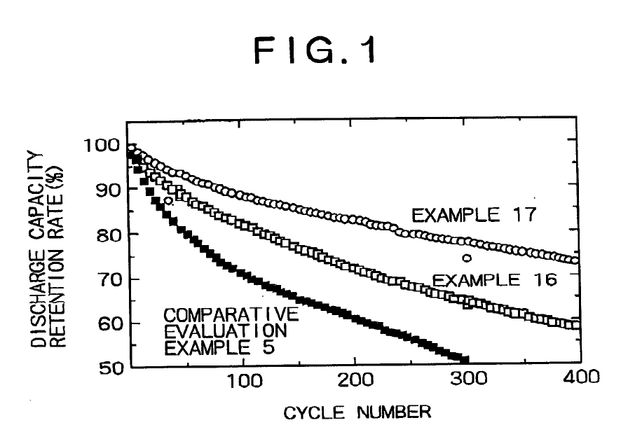

FIG. 1 shows the results of the cycle evaluation test conducted at 50° C. It was found that cycle improvement could be achieved even when all graphite in the positive electrode was not substituted by Ti₂O₃, and addition of Ti₂O₃ was effective even when the 5V-class positive electrode active material to which Si-substitution had been applied was used.

TABLE 1
Evaluation test example 1

| | | Electro- | | |
|---|---|---|---|---|
| | Positive | conduc- | | |
| | electrode | tive | Capacity | Capacity |
| | active | giving | retention | recovery |
| | material | agent | rate (%) | rate (%) |
| Comparative example | LiNi_{0.5}Mn_{1.5}O₄ | graphite | 49 | 64 |
| 1 | | | | |
| Example 1a | LiNi_{0.5}Mn_{1.5}O₄ | TiN | 92 | 94 |
| Example 1b | LiNi_{0.5}Mn_{1.5}O₄ | TiC | 85 | 88 |
| Example 1c | LiNi_{0.5}Mn_{1.5}O₄ | TiSi₂ | 83 | 85 |
| Example 2 | LiNi_{0.5}Mn_{1.5}O₄ | ZrN | 91 | 92 |
| Example 3 | LiNi_{0.5}Mn_{1.5}O₄ | MoO₃ | 85 | 87 |
| Example 4 | LiNi_{0.5}Mn_{1.5}O₄ | TiO | 88 | 91 |
| Example 5 | LiNi_{0.5}Mn_{1.5}O₄ | Ti₂O₃ | 80 | 86 |
| Example 6 | LiNi_{0.5}Mn_{1.5}O₄ | NbO | 82 | 89 |
| Example 7a | LiNi_{0.5}Mn_{1.5}O₄ | RuO₂ | 93 | 94 |
| Example 7b | LiNi_{0.5}Mn_{1.5}O₄ | RuO₂/ | 92 | 94 |
| | | TiN | | |
| Comparative example | LiCoMnO₄ | graphite | 44 | 61 |
| 2 | | | | |
| Example 8a | LiCoMnO₄ | TiN | 85 | 92 |
| Example 8b | LiCoMnO₄ | TiC | 75 | 83 |
| Example 8c | LiCoMnO₄ | TiSi₂ | 74 | 83 |
| Example 9 | LiCoMnO₄ | ZrN | 83 | 91 |
| Example 10 | LiCoMnO₄ | MoO₃ | 76 | 84 |
| Example 11 | LiCoMnO₄ | TiO | 77 | 86 |
| Example 12 | LiCoMnO₄ | Ti₂O₃ | 77 | 84 |
| Example 13 | LiCOMnO₄ | NbO | 82 | 88 |
| Example 14a | LiCoMnO₄ | RuO₂ | 83 | 91 |
| Example 14b | LiCoMnO₄ | RuO₂/ | 84 | 91 |
| | | TiN | | |

TABLE 2
Evaluation test example 2

| | | Electro | | |
|---|---|---|---|---|
| | Positive | conduc- | | |
| | electrode | tive | C300/C5 | C300/C5 |
| | active | giving | (%) | (%) |
| | material | agent | at 20° C. | at 50° C. |
| Comparative example | LiNi_{0.5}Mn_{1.5}O₄ | graphite | 76 | 51 |
| 1 | | | | |
| Example 1a | LiNi_{0.5}Mn_{1.5}O₄ | TiN | 86 | 77 |
| Example 2 | LiNi_{0.5}Mn_{1.5}O₄ | ZrN | 84 | 74 |
| Example 3 | LiNi_{0.5}Mn_{1.5}O₄ | MoO₃ | 84 | 70 |
| Example 4 | LiNi_{0.5}Mn_{1.5}O₄ | TiO | 86 | 73 |
| Example 5 | LiNi_{0.5}Mn_{1.5}O₄ | Ti₂O₃ | 82 | 73 |
| Example 6 | LiNi_{0.5}Mn_{1.5}O₄ | NbO | 80 | 71 |
| Example 7a | LiNi_{0.5}Mn_{1.5}O₄ | RuO₂ | 85 | 75 |
| Comparative example | LiCoMnO₄ | graphite | 74 | 39 |
| 2 | | | | |
| Example 8a | LiCoMnO₄ | TiN | 82 | 74 |
| Example 9 | LiCoMnO₄ | ZrN | 80 | 71 |
| Example 10 | LiCoMnO₄ | MoO₃ | 81 | 72 |
| Example 11 | LiCoMnO₄ | TiO | 80 | 71 |
| Example 12 | LiCoMnO₄ | Ti₂O₃ | 80 | 73 |
| Example 13 | LiCoMnO₄ | NbO | 79 | 71 |
| Example 14a | LiCoMnO₄ | RuO₂ | 82 | 73 |

TABLE 3
Evaluation test example 3

| | Positive | Electro- | | |
|---|---|---|---|---|
| | electrode | conduc- | | Capacity |
| | active | tive giving | Supporting | recovery |
| | material | agent | electrolyte | rate (%) |
| Comparative | LiNi_{0.5}Mn_{1.5}O₄ | Graphite | LiPF₄ | 64 |
| example 1 | | | | |
| Comparative | LiNi_{0.5}Mn_{1.3}Ti_{0.2}O₄ | Graphite | LiPF₆ | 72 |
| example 3 | | | | |
| Comparative | LiNi_{0.5}Mn_{1.3}Ti_{0.2}O₄ | Graphite | LiPF₆ + Li | 74 |
| example 4 | | | (C₂F₅SO₂)₂ | |
| | | N | | |
| Example 15 | LiNi_{0.5}Mn_{1.2}Ti_{0.2}O₄ | TiN | LiPF₆ + Li | 96 |
| | | | (C₂F₅SO₂)₂ | |
| | | | N | |

According to the invention, even in a high-potential condition of 4.5V or more in a metal Li counter electrode, doping of anions that have been generated due to dissociation of a supporting electrolyte into an electroconductive giving agent can be suppressed or reduced, whereby capacity retaining performance and cycle performance at a high temperature are significantly improved.

What as claimed is:

1. A secondary battery positive electrode comprising:
a positive electrode active material which can insert and extract lithium ions; and
an electroconductive giving agent containing one or two or more kinds selected from a group consisting of Ti, Zr, Mo, Nb and compounds containing these elements.

2. The secondary battery positive electrode according to claim 1, wherein said electroconductive giving agent contains one or two or more kinds of compounds selected from a group consisting of TiN, ZrN, MoO₃, TiO, Ti₂O₃, NbO, and RuO₂.

3. The secondary battery positive electrode according to claim 1, wherein the electroconductive giving agent contains a Ti or a Ti-containing compound

4. The secondary battery positive electrode according to claim 3, wherein said electroconductive giving agent contains one or two or more kinds of compounds selected from a group consisting of TiN, TiO, and Ti₂O₃.

5. The secondary battery positive electrode according to claim 1, wherein said compound is one kind selected from a group consisting of oxides, and nitrides.

6. The secondary battery positive electrode according to claim 1, wherein said positive electrode active material has a plateau at 4.5V or more of a metal Li counter electrode potential.

7. The secondary battery positive electrode according to claim 6, wherein said positive electrode active material contains a lithium-containing complex oxide.

8. The secondary battery positive electrode according to claim 7, wherein said lithium-containing complex oxide is a spinel lithium manganese complex oxide.

9. The secondary battery positive electrode according to claim 8, wherein said lithium-containing complex oxide is a compound expressed by a general formula of Liₐ(MxMn_{2-x-y}A_{y})O₄, wherein x, y and a are defined as 0<x, 0 y, x+y<2, and 0<a<1.2, “M” denotes at least one kind selected from a group consisting of Ni, Co, Fe, Cr, and Cu and “A” denotes at least one kind selected from the group consisting of Si and Ti.

10. A secondary battery comprising:
a positive electrode having a positive electrode active material which can insert and extract lithium ions and an electroconductive giving agent which contains one or two or more kinds selected from a group consisting of Ti, Zr, Mo, Nb, and Ru and compounds containing these element;
an anode; and
an electrolyte.

11. The secondary battery according to claim 10, wherein said electrolyte contains LiPF₆ as a supporting electrolyte.

12. The secondary battery according to claim 10, wherein said electroconductive giving agent contains one or two or more kinds of compounds selected from a group consisting of TiN, ZrN, MoO₃, TiO, Ti₂O₃, NbO, and RuO₂.

13. The secondary battery according to claim 10, wherein said electroconductive giving agent contains a Ti simple substance or a Ti-containing compound.

14. The secondary battery according to claim 13, wherein said electroconductive giving agent contains one or two or more kinds of compounds selected from a group consisting of TiN, TiO, and Ti₂O₃.

15. The secondary battery according to claim 10, wherein said compound is an oxide.

16. The secondary battery according to claim 10, wherein said compound is a nitride.

17. The secondary battery according to claim 10, wherein said positive electrode active material has a plateau at 4.5V or more with respect to the lithium reference potential.

18. The secondary battery according to claim 17, wherein said positive electrode active material contains a lithium-containing complex oxide.

19. The secondary battery according to claim 18, wherein said lithium-containing complex oxide is a spinel lithium manganese complex oxide.

20. The secondary battery according to claim 19, wherein said lithium-containing complex oxide is a compound expressed by a general formula of Liₐ(MₓMn_{2-x-y}A_{y})O₄, wherein x, y and a are defined as 0<x, 0 y, x+y<2, and 0<a<1.2, “M” denotes at least one kind selected from a group consisting of Ni, Co, Fe, Cr, and Cu and “A” denotes at least one kind selected between Si and Ti.
